(19) United States
(12) Patent Application Publication
(10) Pub. No.: US 2008/0037519 A1
(43) Pub. Date: Feb. 14, 2008

(54) IP CELLULAR PHONE WITH A REMOTE FUNCTION FOR CONTROLLING A BRIEFING SYSTEM IN A PERSONAL COMPUTER

(76) Inventor: Yung-Lung Liu, Taichung (TW)

Correspondence Address: G.LINK CO.,LTD, 3550 BELL ROAD, MINOOKA, IL, 60447, US

(21) Appl. No.: 11/460,629

(22) Filed: Jul. 28, 2006

(51) Int. Cl. H04L 12/66

(52) U.S. Cl. 370/352

(57) ABSTRACT

An IP cellular phone with a remote function for controlling a briefing system in a personal computer includes a CPU disposed therein. The CPU is electrically connected to a dial module, a voice control module, a remote control module, a trackball module, a laser project module and a wireless transmitter/receiver that are disposed in the IP cellular phone. The wireless transmitter/receiver is provided for reciprocally and wirelessly transmitting the signals between the CPU and the personal computer. As a result, an IP cellular phone is advantageously altered to have the functions of a presenter.

### BACKGROUND OF THE INVENTION

1. Field of the Invention

The present invention relates to an internet protocol (IP) cellular phone, and more particularly to an IP cellular phone with a remote function for controlling a briefing system in a personal computer.

2. Description of Related Art

The conventional telephone or cellular phone use wired or wireless communicate technology for transmitting voice signal such that setting up cables or a wireless transmitting station is necessary. However, the electric communication and internet technology are quickly developed such that IP phone technology is widely used in the internet, such as SKYPE, MSN and YAHOO. The IP phone technology codes voice signals from analogy signals to digital signals and transmits the digital signals to the personal computer or the IP phone of the other side.

However, the functions of the conventional IP phone are insufficient. A presenter is widely used for controlling the briefing system in the personal computer. As a result, more electric product should generate more electromagnetic wave such that to combine two or more electric products and reduce electromagnetic wave becomes important.

The present invention has arisen to mitigate and/or obviate the disadvantages of the conventional IP phone.

### SUMMARY OF THE INVENTION

The main objective of the present invention is to provide an improved IP cellular phone that has a remote function for controlling a briefing system in a personal computer.

To achieve the objective, the IP cellular phone in accordance with the present invention comprises a central processing unit (CPU) disposed in the IP cellular phone for processing voice signals and remote signals from the IP cellular phone. A wireless transmitter/receiver is disposed in the IP cellular phone for reciprocally and wirelessly transmitting the signals between the CPU and the personal computer. A dial module is disposed in the IP cellular phone for forming dial signal and operation signal. A voice control module is disposed in the IP cellular phone for coding voice signals of the operator from analogy signals to digital signals. A remote control module is disposed in the IP cellular phone for forming a remote signal to make the briefing system of the personal computer run an order for turning page. A trackball module is disposed in the IP cellular phone for forming a signal to make the brief system of the personal computer move a cursor of a mouse. A laser project module is disposed in the IP cellular phone for projecting a laser ray via a laser generator to a briefing screen for indicating the information that is shown on the screen.

The IP cellular phone of the present invention has a remote function for controlling a briefing system in a personal computer. As a result, an IP cellular phone is advantageously altered to have the functions of a presenter.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of an IP cellular phone with a remote function for controlling a briefing system in a personal computer of the present invention;

FIG. 2 is a perspective view of an IP cellular phone in accordance with the present invention; and

FIG. 3 is a schematic view of the IP cellular phone of the present invention.

### DETAILED DESCRIPTION OF THE INVENTION

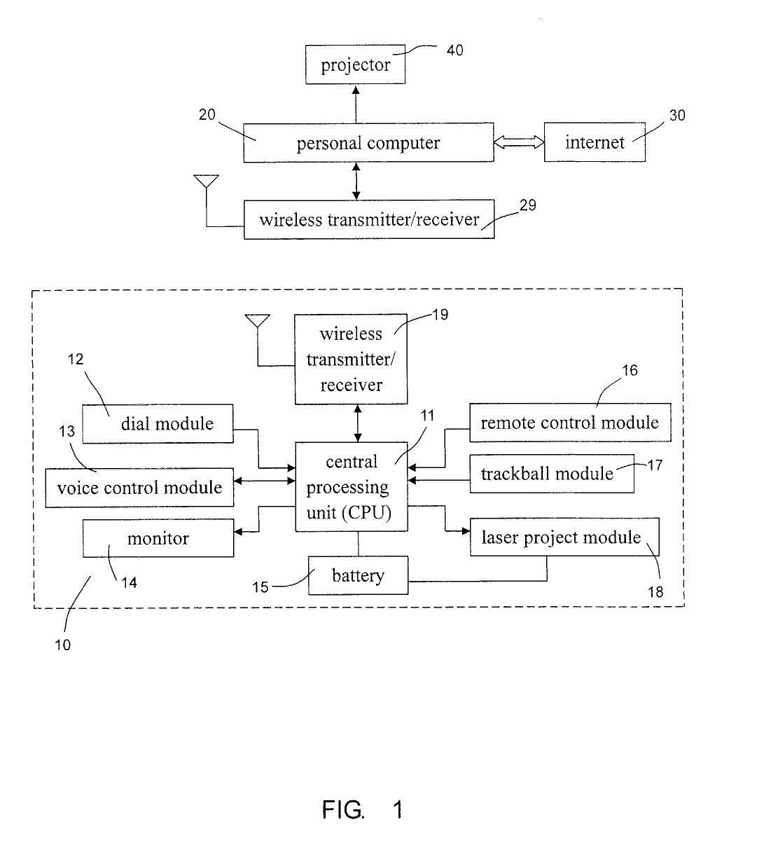

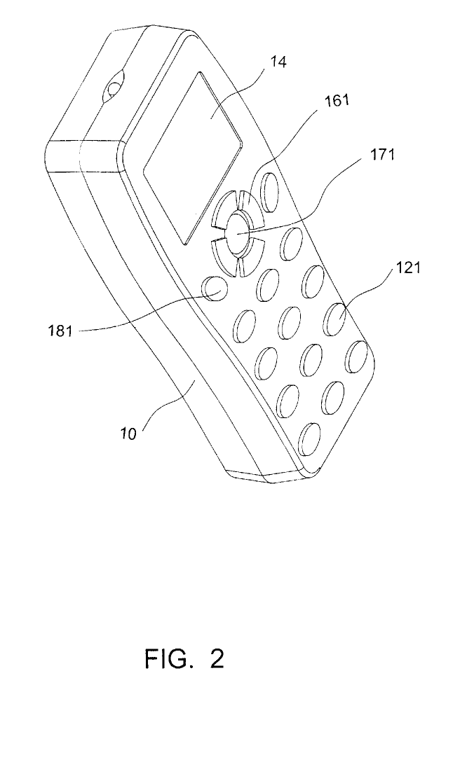

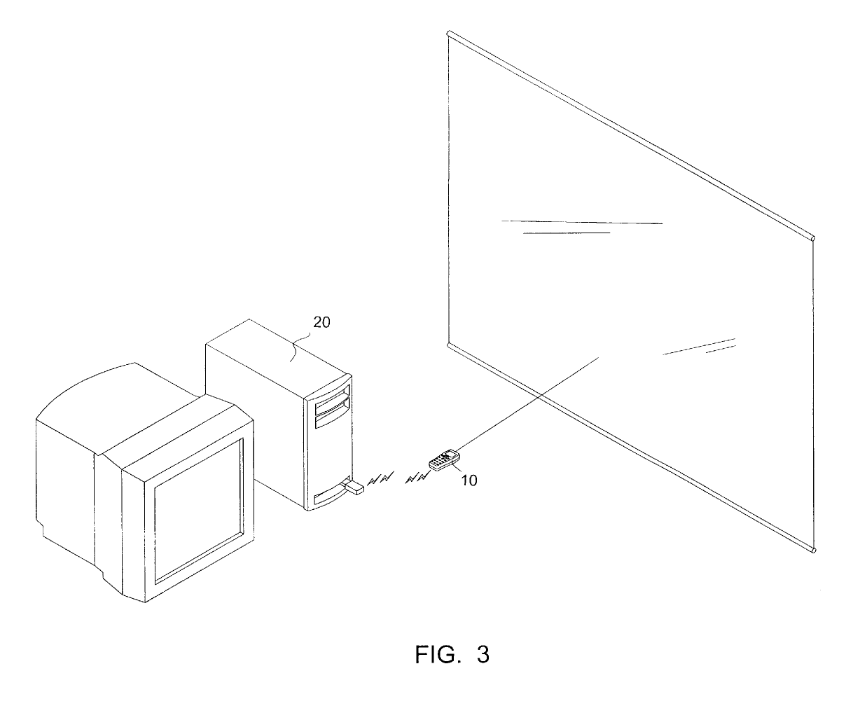

Referring to the drawings and initially to FIGS. 1-3, an IP cellular phone (10) with a remote function for controlling a briefing system in a person computer in accordance with the present invention comprises a central processing unit (CPU) (11), a dial module (12), a voice control module (13), a remote control module (16), a trackball module (17), a laser project module (18), a wireless transmitter/receiver (19) disposed in the IP cellular phone (10). The wireless transmitter/receiver (19) receives signals from and transmits signals to a wireless transmitter/receiver (29) that is mounted on a personal computer (20). The personal computer (20) is electrically connected to an internet (30) and a projector (40) for combining a presenter and an internet communicating device.

The CPU (11) is a micro processor for processing the voice signals from the IP cellular phone (10), the remote signals from the remote control module (16) and the signals from the wireless transmitter/receiver (19). The CPU (11) is respectively and electrically connected to the dial module (12), the voice control module (13) and a monitor (14) that is mounted on the IP cellular phone (10). The dial module (12) comprises a series of dial keys (121) extending through a panel of the IP cellular phone (10). The dial module (12) forms dial signals or operation signals when the series of dial keys (121) are pressed. The signals from the dial module (12) are transmitted to the CPU (11). The voice control module (13) codes the voice signals from the operator from analogy signals to digital signals. The coded voice signals are transmitted to the CPU (11) and processed into signals for bluetooth such that the voice signals are reciprocally and wirelessly transmitted between the personal computer (20) and the internet (30) via the wireless transmitter/receiver (19). The dial number of the IP cellular phone (10) and the operation condition are shown on the monitor (14). A battery (15) is received in the IP cellular phone (10) for providing power to the IP cellular phone (10).

The CPU (11) is respectively and electrically connected to the remote control module (16), the trackball module (17) and the laser project module (18). The remote control module (16) has a series of remote keys (161) extending through the panel of the IP cellular phone (10) and the trackball module (17) has a trackball (171 ) partially and rotatably mounted in the panel of the IP cellular phone (10). The remote control module (16) forms a remote signal when the remote keys (161) are pressed and the remote signal is processed into a bluetooth signal after transmitted to the CPU (11) and transmitted to the wireless transmitter/receiver (29) of the personal computer (20) via the wireless transmitter/receiver (19) to make the brief system of the personal computer (20) run an order for turning page. The trackball module (17) forms a signal when the trackball (171 ) is rotated and the signal is processed into a bluetooth signal after transmitted to the CPU (11) and transmitted to the wireless transmitter/receiver (29) of the personal computer (20) via the wireless transmitter/receiver (19) to make the brief system of the personal computer (20) move the cursor of the mouse. The laser project module (18) has a key (181) extending through the panel of the IP cellular phone (10). The laser project (18) projects a laser ray via a laser generator (not shown) to a briefing screen of a projector (40) for indicating the information that is shown on the screen. In the preferred embodiment of the present invention, the laser generator is a laser diode for generating a semi-conductor laser light source.

As described above, the IP cellular phone (10) in accordance with the present invention has the advantages as hereinafter described. The IP cellular phone of the present invention has a remote function for controlling a briefing system in a personal computer. As a result, an IP cellular phone is advantageously altered to have the functions of a presenter.

Although the invention has been explained in relation to its preferred embodiment, it is to be understood that many other possible modifications and variations can be made without departing from the spirit and scope of the invention as hereinafter claimed.

What is claimed is:

1. An IP cellular phone with a remote function for controlling a briefing system in a personal computer, comprising:
a central processing unit (CPU) disposed in the IP cellular phone for processing voice signals and remote signals from the IP cellular phone, a wireless transmitter/receiver disposed in the IP cellular phone for reciprocally and wirelessly transmitting the signals between the CPU and the personal computer;
a dial module disposed in the IP cellular phone for forming dial signal and operation signal;
a voice control module disposed in the IP cellular phone for coding voice signals from the operator from analogy signals to digital signals;
a remote control module disposed in the IP cellular phone for forming a remote signal to make the briefing system of the personal computer run an order for turning page;
a trackball module disposed in the IP cellular phone for forming a signal to make the brief system of the personal computer move a cursor of a mouse; and
a laser project module disposed in the IP cellular phone for projecting a laser ray via a laser generator to a briefing screen for indicating the information that is shown on the screen.

2. The IP cellular phone as claimed in claim 1, wherein the CPU processes the signals to bluetooth signals.

3. The IP cellular phone as claimed in claim 1 further comprising a monitor mounted thereon and electrically connected to the CPU for displaying dial numbers and operation condition.

4. The IP cellular phone as claimed in claim 1, wherein the laser generator is a laser diode for generating a semi-conductor laser light source.
